(19) United States
(12) Patent Application Publication
(10) Pub. No.: US 2018/0121506 A1
(43) Pub. Date: May 3, 2018

(54) SOLVING GRAPH ROUTES INTO A SET OF POSSIBLE RELATIONSHIP CHAINS

(71) Applicant: HEWLETT PACKARD ENTERPRISE DEVELOPMENT LP, Houston, TX (US)

(72) Inventors: Marco Aurelio Barbosa Fagnani Gomes Lotz, Bristol (GB); James Brook, Bristol (GB); Luis Miguel Vaquero Gonzalez, Bristol (GB)

(21) Appl. No.: 15/337,316

(22) Filed: Oct. 28, 2016

(51) Int. Cl. G06F 17/30; H04L 12/26

(52) U.S. Cl. CPC G06F 17/30466; H04L 43/045; G06F 17/30469; G06F 17/30569; G06F 17/30867; G06F 17/30958

(57) ABSTRACT

Example embodiments relate to solve a graph route into a set of possible relationship chains. The example disclosed herein receives a graph route, identifies an edge expansion wildcard based on the graph route, expands the graph route into a plurality of sub-graph routes based on the edge expansion wildcard, solves the plurality of sub-graph routes in parallel into a plurality of sub-graph routes results, and joins the plurality of sub-graph routes results into a set of possible relationship chains.

### BACKGROUND

Enterprises may use graph database methods on top of their relational databases due to its ease and simplicity. Extracting the queried data in the most efficient way may provide the enterprise with a competitive advantage and add significant value.

### BRIEF DESCRIPTION OF THE DRAWINGS

Figures of the present disclosure are illustrated by way of example(s) and not limited in the following figure(s) in which like numerals indicate like elements, in which:

FIG. 1 is a graph topology file to illustrate the combinatorial explosion paths, according to an example of the present disclosure.

FIG. 2 is a block diagram illustrating a system for solving a graph route into a set of possible relationship chains, according to an example of the present disclosure.

FIG. 3 is a block diagram illustrating additional instructions of the system for solving a graph route into a set of possible relationship chains, according to an example of the present disclosure.

FIG. 4 is a graph topology file to illustrate an example of the edge wildcard expansion effect on a graph route expansion to define the plurality of sub-graph routes, according to an example of the present disclosure.

FIG. 5A is a flowchart of a method for solving a graph route into a set of possible relationship chains, according to an example of the present disclosure.

FIG. 5B is a flowchart of a method to identify segments in a sub-graph route that includes at least a directed edge, according to an example of the present disclosure.

FIG. 5C is a flowchart of method to identify segments in a sub-graph route that includes undirected edges, according to an example of the present disclosure.

FIG. 6 is a block diagram illustrating a system for solving a graph route into a set of possible relationship chains, according to an example of the present disclosure.

FIG. 7 is a flowchart illustrating a method for solving a graph route into a set of possible relationship chains, according to an example of the present disclosure.

### DETAILED DESCRIPTION

The following discussion is directed to various examples of the disclosure. The examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

Structured Query Language (SQL), is commonly used to query databases managed by Relational Database Management Systems (RDBMS). Due to syntax structure of SQL language, some special queries may be difficult to implement and, when written, may generate long statements without a clear description of what is being performed. These complexities may be evident in most graph operations performed in RDBMSs, where many of sequential relational tables may need to be joined in order to run graph traversal examples. Furthermore, graph operations may demand a huge number of sequential table joins, which may be a very computationally expensive operation when run on large datasets.

Due to the previous technical challenge of performing graph operations in SQL, RDBMS researchers have transitioned to database management systems using graph theory, which are known as Graph Database Management Systems (GDBMS). GDBMS query language, Graph Query Language (GQL), includes mechanisms specialized in graph storage that provide a quick graph traversal operations associated with simple domain specific queries.

The present disclosure may refer to graph theory concepts such as nodes or edges. As disclosed herein, nodes may be the entities of a query, concepts or classes of objects, or in other words, those elements the query may want to extract information from. In graph theory, nodes may be the vertex, and therefore the fundamental units of which graphs are formed.

Edges may be relationships between the nodes in the query. In graph theory, edges may be relationships between vertices. According to graph theory, edges can be either directed edges or undirected edges. Directed edges have a direction: for example, given a source and a destination node, the edge relationship only works one way, and therefore the relationship exists from the source node to the destination node. Otherwise, undirected edges do not have direction: for example, given a source and a destination node, the edge relationship works two ways, and therefore the relationship exists both from the source node to the destination node and from the destination node to the source node. Both directed edges and undirected edges may appear in a single graph topology, and therefore there may be three types of graph topologies according to the edge types in the graph topology: graph topologies that only include directed edges, graph topologies that include both directed edges and undirected edges, and graph topologies that only include undirected edges.

In some examples, graph queries may be unspecific, which means that the query may not indicate what node type is the desired target node. These unspecific nodes may be denominated as anonymous nodes hereinafter. If the query includes an anonymous node target (i.e., the node type is not specified), the SQL syntax may be complex and hard to understand and debug. Therefore, for simplicity reasons, GQL queries may be used. Additionally, several query operations could be pruned based on a graph layout that would not be pruned on an RDBMS SQL query, thus reducing the response time and computational cost.”

In the present disclosure, the graph route may be an input from either a user or a machine instruction. The graph route may show the desired path that the user wants the operation to follow. In the present disclosure a path may be understood as a finite or infinite sequence of edges which connect a sequence of nodes. Given a source and destination node, a route (or path) is any connection of edges and its respective nodes that goes from the source node to the destination node. There may be multiple routes that go from the source node to the destination node, and therefore there may be shorter and longer routes. The length of the route may be measured in hops. For example, if a route contains three nodes (including the source and the destination node), the path may include three hops. To give a general example, if a path has N nodes (including the source and the destination node), the path may include N−1 hops.

Examples disclosed herein may relate to, among other things, solving graph routes into a set of possible relationship chains. In some implementations, a graph route from a user or machine instruction is received and the graph route edge expansion wildcard is identified. The graph route may be further expanded into a plurality of sub-graph routes based on the edge expansion wildcard of the graph route. Each of the sub-graph routes is solved in parallel into a plurality of sub-graph results and joined together into a set of possible relationship chains. Some implementations may further use a graph topology file to perform the foregoing functionality. Given a graph topology and once the graph route is received, some examples may perform a combinatorial explosion of all the possible routes. By virtue of the foregoing, the system may find a graph route solution faster and using less resources, as of an early stage pruning to remove illogical solutions, breaking the complex problem into several simpler sub-problems; and looking at the template (e.g. graph topology file) and therefore may not be required to look at the data in the database.

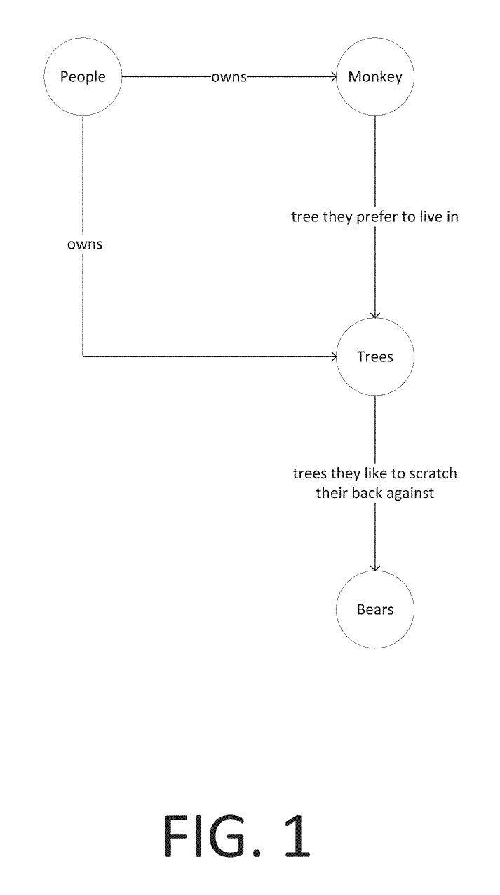

Referring now to the drawings, FIG. 1 depicts a graph topology file to illustrate combinatorial explosion paths, according to an example of the present disclosure. For example, the graph topology file of FIG. 1 includes a set of nodes and directed edges. The nodes may include an underlying database of tables People, Monkey, Trees and Bears. The edges may be the relationships between the aforementioned tables. The table Monkey is related to the table People as it includes the monkeys owned by each person of the table People. The table Tree is related to the table People as it includes the trees owned by each person of the table People. The table Tree is further related to the table Monkey as it includes the trees that each monkey prefers to live in. The table Tree is further related to the table Bears as it includes the trees that each bear prefers to scratch their back on.

In the present disclosure, a query language used in the graph route may be any GQL language (e.g. Cypher, Gremlin etc.). However, for simplicity Cypher may be used as an example hereinafter.

The user or a machine instruction may input the following graph route on top of the graph topology of FIG. 1:

MATCH(m)->( )>(:Bears) RETURN m

The previous route query asks to return all vertices that are two hops away from a bear, using only outgoing edges from the original vertex referenced as the variable “m”. Therefore, the result may be a list of all the monkeys or people that are two hops away from the bears.

In the previous example, the type of the source node is not defined, therefore the source node is an anonymous node. A combinatorial explosion of all the nodes within the graph topology file may be performed. For example, FIG. 1 combinatorial explosion includes four nodes, and therefore there are twelve possible combinations that end at node Bear. These twelve combinations are set forth in the following table.

People -> Monkey -> Bears
People -> Trees -> Bears
People -> Bears -> Bears
Monkey -> People -> Bears
Monkey -> Trees -> Bears
Monkey -> Bears -> Bears
Trees -> People -> Bears
Trees -> Monkey -> Bears
Trees -> Bear -> Bears
Bear -> People -> Bears
Bear -> Monkey -> Bears
Bear -> Trees -> Bears

However, there may be only three possible solutions that are allowable by both the graph topology file and the given graph route. To give a first example, the first combination from the table “People->Monkey->Bear” may not be possible as the node Monkey is not directly related to the node Bear in the graph topology file. To give a second example, the twelfth combination from the table “Bear->Trees->Bear” may not be possible as the node Bear does not have an outgoing edge to the node Tree, and therefore the given graph route is not met. Finally, to give a third example, the second combination from the table “People->Trees->Bears” may be possible according to the graph topology file and the given graph route.

On an RDBMS, the previous example may be expanded to the twelve combinations in parallel and may be concatenate with a “union all”. Many of these queries may result in incongruent or empty result sets that may not be faithful to rules provided by the graph topology file. The method of these examples may be effective but may request running the analysis as many times as the number of combinatorial explosion combinations. The previous may lead to a waste of resources and unnecessary work done while fetching the data from the database that return unrequested intermediary results, the previous may not be an efficient method.

Examples of the present disclosure may utilize a graph topology file to filter the different combinations, thus saving code complexity in the mapping between a graph topology and RDBMS tables, and minimizing RDBMS execution time. In the present disclosure, the term mapping may be understood as graph topology representation of the plurality of tables within a RDBMS.

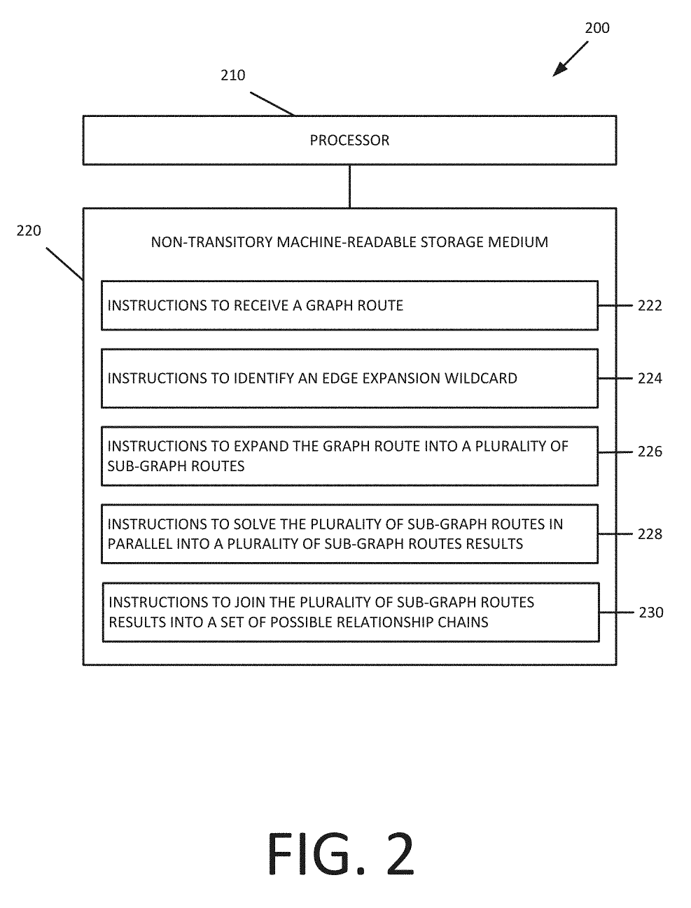

FIG. 2 is a block diagram illustrating a system 200 for solving a graph route into a set of possible relationship chains, according to an example of the present disclosure. FIG. 2 describes a system 200 that includes a physical processor 210 and a non-transitory machine readable storage medium 220. The processor 210 may be a microcontroller, a microprocessor, central processing unit (CPU) core, an application-specific integrated circuit (ASIC), a field programmable gate array (FPGA), and/or the like. The machine readable storage medium 220 may store or be encoded with instructions 222, 224, 226, 228, 230 that may be executed by the processor 210 to perform the functionality described herein.

In an example, the instructions 222-230, and/or other instructions can be part of an installation package that can be executed by processor 210 to implement the functionality described herein. In such a case, non-transitory machine readable storage medium 220 may be a portable medium such as a CD, DVD, or flash device or a memory maintained by a computing device from which the installation package can be downloaded and installed. In another example, the program instructions may be part of an application or applications already installed in the non-transitory machine-readable storage medium 220.

The non-transitory machine readable storage medium 220 may be any electronic, magnetic, optical, or other physical storage device that contains or stores executable data accessible to the system 200. Thus, non-transitory machine readable storage medium 220 may be, for example, a Random Access Memory (RAM), an Electrically Erasable Programmable Read-Only Memory (EEPROM), a storage device, an optical disc, and the like. The non-transitory machine readable storage medium 220 does not encompass transitory propagating signals. Non-transitory machine readable storage medium 220 may be allocated in the system 200 and/or in any other device in communication with the system 200.

In the example of FIG. 2, the instructions 222, when executed by the processor 210, cause the processor 210 to receive a graph route. The input of the system is a graph route provided by either a user or a machine learning instruction.

The instructions 224, when executed by the processor 210, cause the processor 210 to identify an edge expansion wildcard based on the graph route (e.g. graph route received from the execution of instructions 222). In the present disclosure, the graph route provided may indicate an origin node, a destination node, and a wildcard. The origin node may be the entity wherein the dataflow is referenced to start. The destination node may be the entity wherein the dataflow is referenced to end. However, the graph route provided may further indicate path constraints, such as a wildcard, which indicates how many maximum hops are allowed from the origin node to the destination node. The origin node and the destination node may be anonymous nodes, either alone or in combination.

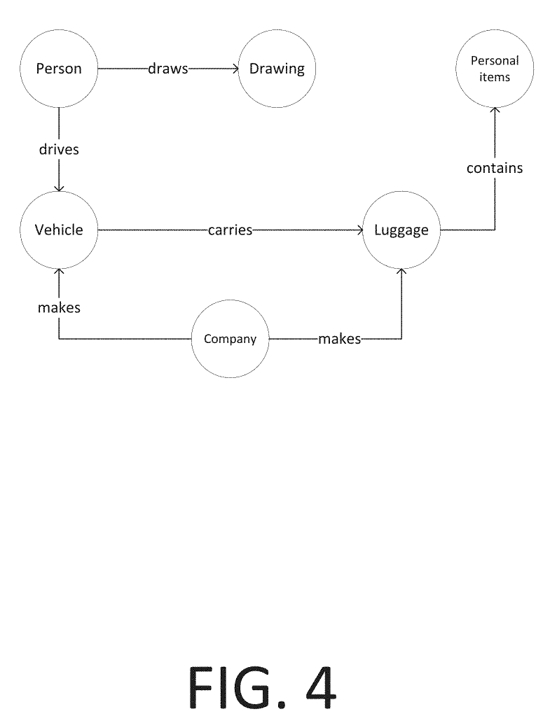

The instructions 226, when executed by the processor 210, cause the processor 210 to expand the graph route into a plurality of sub-graph routes based on the edge expansion wildcard (e.g. edge expansion wildcard received by execution of instructions 224). As mentioned above, the graph route may have an edge expansion wildcard number bigger than one. In that case, the processor 210 may split the graph route into as many problems as the multiplication of all ranges in all edge wildcard expansions in the original route. In the present disclosure, each of the splits may be denominated as sub-graph routes. In a first example, if a graph route has a wildcard equal to three, it may be expanded into three different sub-graph routes: a 1-hop sub-graph route, a 2-hop sub-graph route, and a 3-hop sub-graph route. In a second example, if a graph route has a wildcard equal to N, wherein N is a positive integer, it may be expanded into N different sub-graph routes: starting from the 1-hop sub-graph route, followed by the 2-hop sub-graph route, and so on up to the N-hop sub-graph route. For example, FIG. 4 discloses an example of edge expansion wildcard based on a given graph route, as will be described further herein below.

The instructions 228, when executed by the processor 210, cause the processor 210 to solve the plurality of sub-graph routes (e.g. plurality of sub-graph routes received by execution of instructions 226) in parallel into a plurality of sub-graph routes results. For example, once the plurality of N sub-graph routes are defined, the processor 210 may solve them by finding the possible paths for every single sub-graph route in parallel. As the processor 210 may solve each sub-graph route in parallel, the time invested in solving the plurality of sub-graph routes may be equal to the time invested in solving the sub-graph route that takes the most time to solve. Each of the possible paths is a sub-graph route result.

The instructions 230, when executed by the processor 210, cause the processor 210 to join the plurality of sub-graph routes results (e.g. sub-graph route results received by execution of instructions 228) into a set of possible relationship chains. In the present disclosure, the set of possible relationship chains may be understood as all the graph topology routes that fit the conditions of the given graph route and in the light of the graph topology file without any anonymous node nor edge expansion wildcard.

For example, looking at FIG. 1, a user may introduce the graph route “MATCH(m)->( )->(:Bears) RETURN m” to system 100 (e.g. instructions 222). Then, the processor 210 may identify the edge expansion wildcard from the graph route, which in FIG. 1 example may be 2, as the given graph route is asking to return all vertices that are two hops away from a node of type bear (e.g. instructions 224). The processor 210 may further expand the graph route into a plurality of sub-graph routes (e.g. instructions 226). The processor 210 may further solve the plurality of sub-graph routes in parallel into a plurality of sub-graph routes results (e.g. instructions 228), which in FIG. 1 example may be “People->Trees->Bears”, “Monkey->Trees->Bears”, and “Trees->Bears”. The processor 210 may further join the plurality of sub-graph routes results into a set of possible relationship chains (e.g. instructions 230).

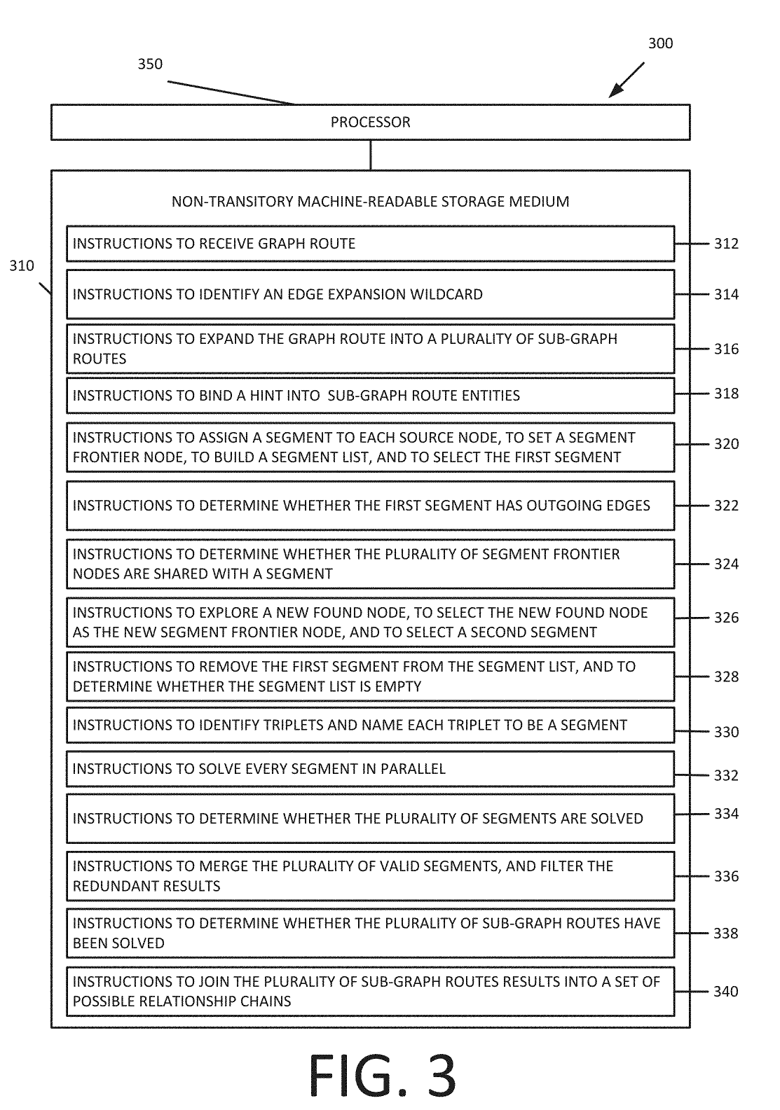

FIG. 3 is a block diagram illustrating additional instructions of the system 300 for solving a graph route into a set of possible relationship chains, according to an example of the present disclosure. System 300 includes a processor 350 and a non-transitory machine readable storing medium 310. The non-transitory machine readable storage medium 310 stores or is encoded with instructions 312, 314, 316, 318, 320, 322, 324, 326, 328, 330, 332, 334, 336, 338, 340 Instructions 312, 314, 316, and 340 may be analogous in many respects to instructions 222, 224, 226 and 230, respectively. In some implementations, instructions 318-338 may be sub-instructions of FIG. 1 instruction 228.

The instructions 312, when executed by the processor 350, may cause the processor 350 to receive a graph route. The instructions 314, when executed by the processor 350, may cause the processor 350 to identify an edge expansion wildcard based on the graph route. The instructions 316, when executed by the processor 350, may cause the processor 350 to expand the graph route into a plurality of sub-graph routes based on the edge expansion wildcard.

The instructions 318, when executed by the processor 350, may cause the processor 350 to bind a hint into sub-graph route entities. The sub-graph route of the present disclosure may include a plurality of entities, for example sub-graph route nodes and sub-graph route edges. The sub-graph route may include at least a sub-graph route node and may also include at least a sub-graph route edge.

Hints utilized by instructions 318 may be included in a graph topology file. For example, the graph topology file may include additional information of the sub-graph route nodes and sub-graph route edges, for example node type information or edge type information. These pieces of information, or hints, may define some properties of the sub-graph route nodes and sub-graph edges. These hints may be defined as node type hints at hints that involve a sub-graph route node, and edge type hints at hints that involve a sub-graph edge node.

Instructions 318, may check the graph topology file to find hints for sub-graph route entities and apply the found hints to the sub-graph route. For example, given a sub-graph route that includes an anonymous node and a hint from the graph topology file that indicates that the anonymous node is from type “People”, the instructions 318 may cause the processor 350 to bind the found hint into sub-graph route entities, and therefore replace the anonymous node for a node of type “People”. After applying the aforementioned hints, the system 300 may require less computing resources and may compute faster when further solving the sub-graph route. For example, the anonymous node identified as node type “People”, may not require to be computed by processor 350 with other node types such as “Monkey”, “Trees” or “Bears”. For example, hints for nodes or edges may be equivalents to the properties that nodes or edges may have in Cypher language.

The instructions 320, when executed by the processor 350, may cause the processor 350 to, given a sub-graph route expanded by instructions 316 that includes at least one directed edge, assign a segment to each source node. A source node may be a node from the sub-graph route that only has either outgoing edges or no edges. Due to syntax, every sub-graph route may have at least one source node. The instructions 320, may cause the processor 350 to identify those source nodes within the sub-graph route if the graph topology includes only directed edges or the graph topology includes both directed edges and undirected edges. Once the source nodes have been identified, instructions 320 may further cause the processor 350 to define the source nodes as a frontier nodes of a segment, and therefore each sub-graph route may have a plurality of segments. In the present disclosure, a frontier node may be understood as a node that is in the periphery of a segment. Instructions 320 may further cause the processor 350 to include the aforementioned segments into a segment list, and select the first segment of the segment list.

The instructions 322, when executed by the processor 350, may cause the processor 350 to determine whether the first selected segment has outgoing edges. The instructions 324, when executed by the processor 350, may cause the processor 350 to determine whether the plurality of segment frontier nodes defined by instructions 320 are shared with a segment (e.g. any segment from the segment list generated by the execution of instructions 320). If the frontier node of the first selected segment has an outgoing edge, the instructions 324 may cause the processor 350 to determine whether the outgoing edge links to a node owned by another segment from the segment list, and such node is then deemed a new found node.

The instructions 326, when executed by the processor 350, may cause the processor 350 to explore the new found node, to select the new found node as the new segment frontier node, and to select a second segment. If the outgoing edge from the segment frontier node does not link to a node owned by another segment from the segment list, then instructions 326 may further cause the processor 350 to include the outgoing edge to the segment and redefine the new found node as the new segment frontier node. It may be understood that for new found node it is referred as the node that is not linked to a node owned by another segment from the segment list.

The instructions 328, when executed by processor 350, may cause the processor 350 to remove the first segment from the segment list, and to determine whether the segment list is empty. If either the first segment of the list frontier nodes have not outgoing edges or the plurality of segment frontier nodes are shared with a segment from the segment list other than the first segment, the instructions 328 may further cause the processor 350 to remove the first segment from the segment list and to determine whether the segment list is empty or not. If it is determined that the list is not empty, the instructions 328 cause the processor 350 to repeat instructions 320-328 until the list is determined to be empty.

The system 300 executes instructions 320-328 to identify segments that includes at least a directed edge within sub-graph route. In the cases that the sub-graph route includes undirected edges, system 300 may execute instructions 330 that cause the processor 350 to identify triplets. In the present disclosure triplets may be understood as a group of three sub-graph route entities that are connected directly (e.g. a node-edge-node group in any neighborhood nodes in a sub-graph route). Instructions 330 may further cause the processor 350 to assign each triplet a segment, therefore outputting a plurality of segments for a plurality of identified triplets.

The instructions 332, when executed by processor 350, may cause the processor to solve every segment in parallel. In the present disclosure, solving a segment may be understood as determining the set of paths that match the graph topology file and the sub-graph route within a segment. However some of the previous segments solutions may not be relevant to the graph-route. Instructions 332 may further cause the processor 350 to determine which of the solved segments are relevant to the graph route, based on the graph topology file, renaming them as plurality of valid segments.

The instructions 334, when executed by processor 350, may cause the processor 350 to determine whether the plurality of segments are solved. Because each segment from the plurality of segments may have different complexity, the processor 350 may take different amounts of time to solve each of the segments. As the segments may be solved in parallel, the amount of time invested to solve the plurality of segments may be the same as the amount of time invested by the segment that takes the most time to solve and therefore, speeding the answering time.

The instructions 336, when executed by the processor 350, may cause the processor 350 to merge the plurality of valid segments (e.g. all valid segments received by the execution of instructions 332), and filter the redundant results, therefore solving the sub-graph query. In the present disclosure, segment merging may be understood as a method that may concatenate compatible segments. The term compatible segments may further be understood as segments where the end of a first segment is the beginning of a second segment. In some implementations, instructions 336 may be performed after or triggered by the determination by instructions 334 that all segments have been solved.

The instructions 338, when executed by the processor 350, may cause the processor 350 to determine whether the plurality of sub-graph routes have been solved. As the sub-graph routes may be solved in parallel, the amount of time invested to solve the plurality of sub-graph routes may be the same as the amount of time invested by the sub-graph route that takes the most time to solve and therefore, speeding the answering time.

The instructions 340, when executed by processor 350, when executed by the processor 350, may cause the processor 350 to join the plurality of sub-graph routes results into a set of possible relationship chains (e.g. once the processor 350 may have determined that the plurality of sub-graph routes received from execution of instructions 338 have been solved).

FIG. 4 is a graph topology file to illustrate an example of the edge wildcard expansion effect on a graph route expansion to define the plurality of sub-graph routes, according to an example of the present disclosure. For example, the graph topology file of FIG. 4 includes a set of nodes and edges. The nodes may include an underlying database of tables “Person”, “Drawing”, “Vehicle”, “Company”, “Luggage”, and “Personal items”. The edges may be the relationships between the aforementioned tables. The table “Drawing” is related to the table “Person” as it includes the drawings drown by each person of the table “Person”. The table “Vehicle” is related to the table “Person” as it includes the vehicles owned by each person of the table “Person”. The table “Vehicle” is further related to the table “Company” as it includes the vehicles made by each company of the table “Company”. The table “Luggage” is related to the table “Company” as it includes the luggage that is made by each company of the table “Company”. The table “Luggage” is further related to the table “Vehicle” as it includes the luggage carried by each vehicle from the table “Vehicle”. Finally, the table “Personal items” is related to the table “Luggage” as it includes the personal items that are in each luggage from the table “Luggage”.

A user or a machine instruction may input the following graph route on top of the graph topology example of FIG. 4, for example:

( )<-(m:Person)-[1..2]->(n)->(c)

The previous graph route may be referencing an anonymous node as the variable “n”. Ignoring the context of the node in the path layout, any possible node type in the database would match. The numbers “1..2” inside the directed edge may indicate that one or two outgoing edge hops from node “m” should be a node that will be referenced by variable “n”, therefore “2” may indicate the edge expansion wildcard, as defined above.

According to the previous example and the graph topology from FIG. 4, only four paths would match the description and be congruent with the graph topology, which are listed in the following table. These four paths are the plurality of sub-graph routes of the example.

(:Drawing) <- [:draws]-(:Person)-[:drives] -> (:Vehicle) <- [:makes]-
(:Company)
(:Vehicle) <- [:drives]-(:Person)-[:drives] -> (:Vehicle) <- [:makes]-
(:Company)
(:Drawing) <- [:draws]-(:Person)-[:drives] -> (:Vehicle)-[:carries] ->
(:Luggage) <-[:makes]-(:Company)
(:Vehicle) <- [:drives]-(:Person)-[:drives] -> (:Vehicle)-[:carries] ->
(:Luggage) <- [:makes]-(:Company)

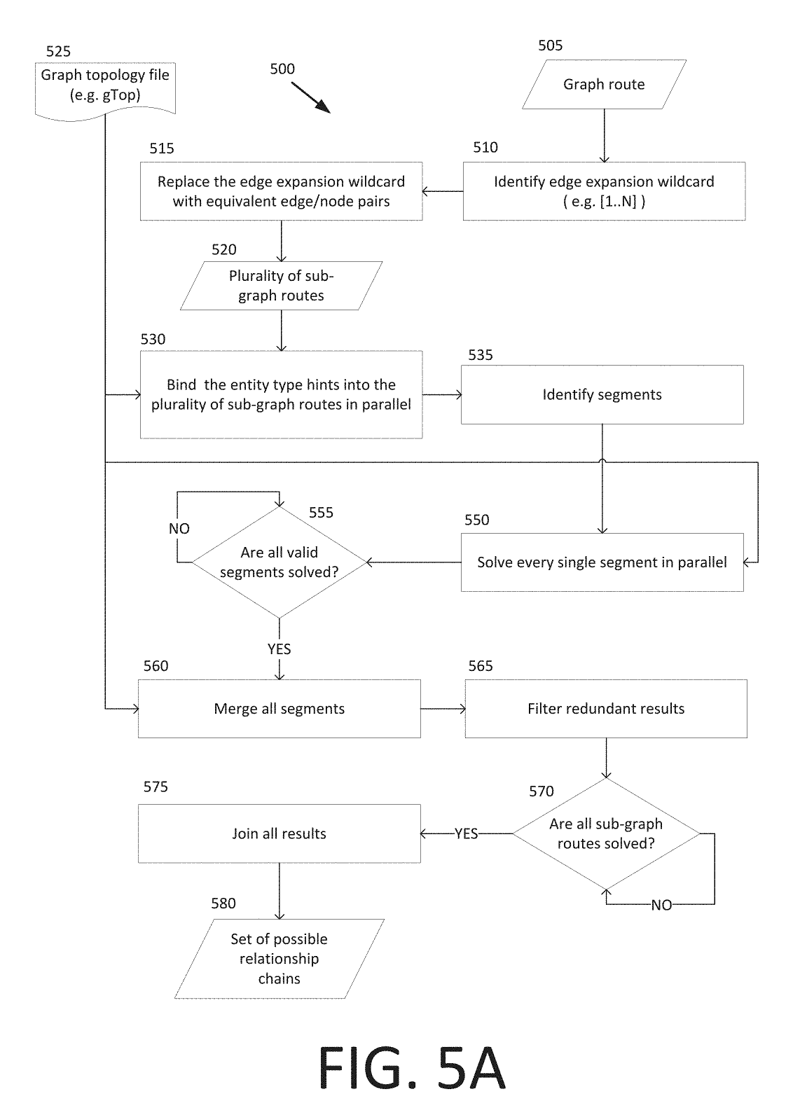

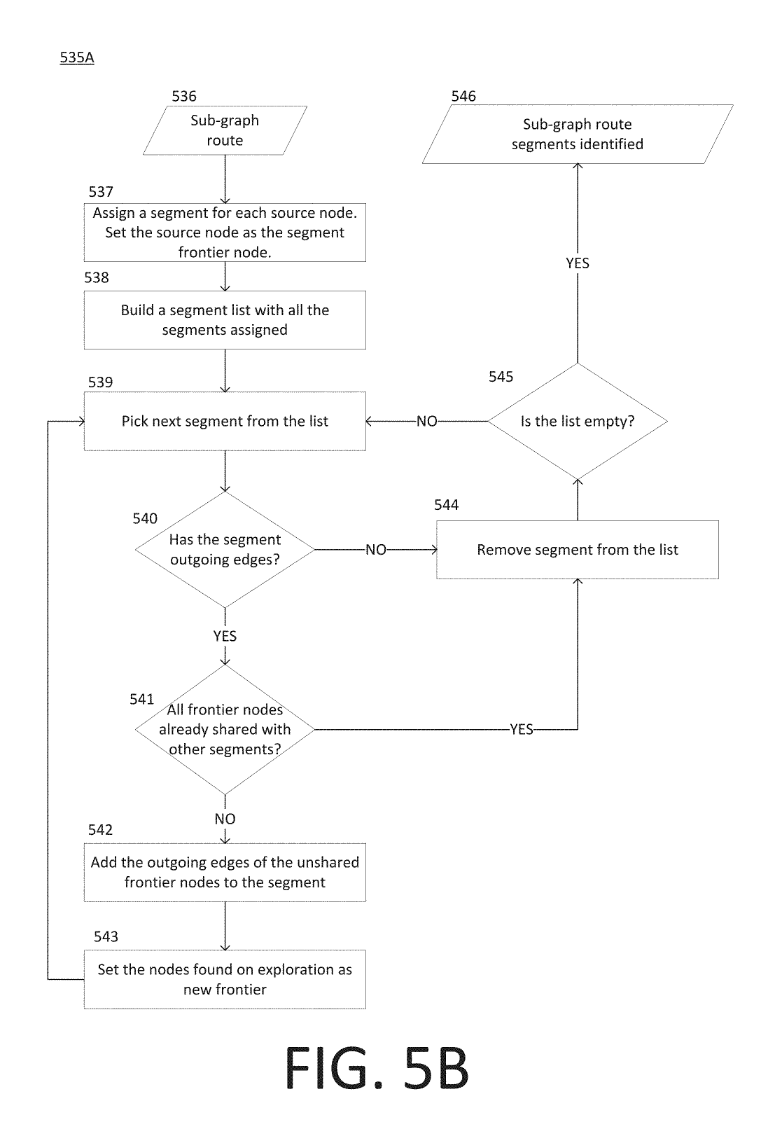

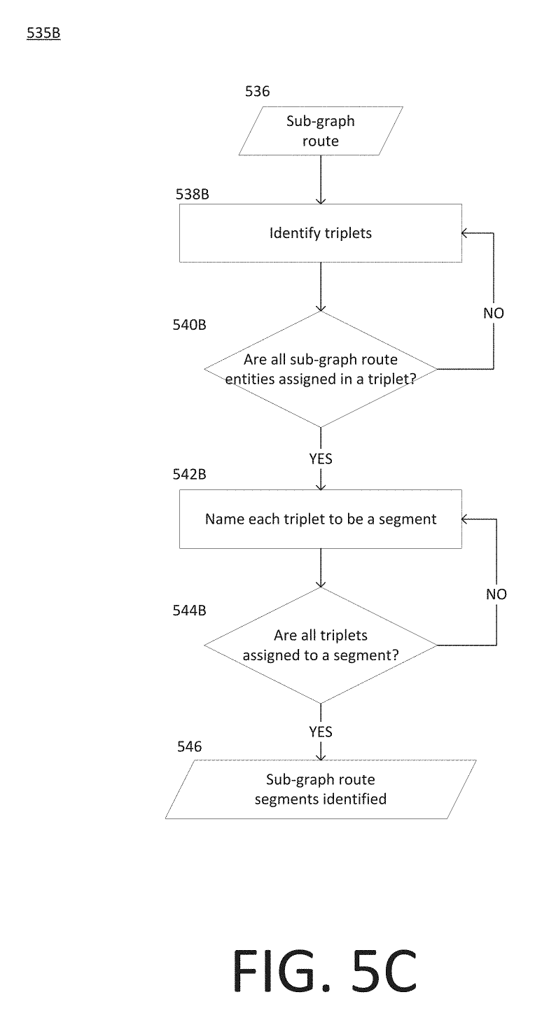

FIG. 5A is a flowchart of a method 500 for solving a graph route into a set of possible relationship chains, according to an example of the present disclosure. FIG. 5A may be performed by processor 350 from system 300.

A user or a machine instruction may input a graph route 505. At block 510, the processor 350 may identify the edge expansion wildcard which indicates how many maximum hops are allowed from the origin node to the destination node. At block 515 the processor 350 may replace the edge expansion wildcard with the equivalent edge and node pairs. The output of block 515 is a plurality of sub-graph routes 520.

The processor 350 may perform the method from block 530 to block 565 in parallel for each of the sub-graph routes within the plurality of sub-graph routes 520. For convenience, blocks 530, 535, 550, 555, 560, 565 will be described below with reference to a single sub-graph route of the plurality of sub-graph routes, although the description applies equally to all sub-graph routes being processed in parallel.

The processor 350 may access a graph topology file 525 and the sub-graph route. At block 530, the processor 350 may bind the entity type hints from the graph topology file 525 into the sub-graph route. The entity type hints include node type hints and edge type hints. The output from block 530 is a plurality of sub-graph routes with the entity hints bound.

At block 535 the processor 350 may identify a plurality of segments in the sub-graph route. Block 535 may be performed, for example, by two different methods depending on the graph topology edge types. If the graph topology includes at least one directed edge, an example of the method of block 535 is disclosed in FIG. 5B. If the graph topology includes undirected edges, an example of the method of block 535 is disclosed in FIG. 5C.

At block 550, the processor 350 may solve every single segment from the plurality of segments identified at block 535 in parallel to generate a plurality of valid segments. At decision block 555, the processor 350 may check whether all valid segments are solved and may not move to block 560 unless all valid segments are solved. At block 560, the processor 350 may merge all valid segments based on the plurality of valid segments and the graph topology file. Furthermore, at block 565, the processor 350 may filter all redundant results into a sub-graph route result. As the method from block 530 to block 565 may be done to each sub-graph route in parallel, the output of block 565 is a plurality of sub-graph route results. At decision block 570, the processor 350 may determine whether every single sub-graph route result from the plurality of sub-graph route results has been solved and may not move to block 575 unless every single sub-graph route within the plurality of sub-graph route results has been solved.

At block 575, the processor 350 may join all the results from the plurality of sub-graph route results into a set of possible relationship chains 580. The set of possible relationship chains 580 may be the output of the method 500.

In the example of FIG. 5B, the system 300 may take for example a sub-graph route 536 (e.g., outputted by block 515 described above), that may include at least one directed edge as an input and identify the plurality of segments within the sub-graph route. FIG. 5B is a flowchart of a method to identify segments 535 in a sub-graph route that includes at least one directed edge, according to an example of the present disclosure.

At block 537, processor 350 may assign a segment for each source node and set the assigned source node as the segment frontier node. At block 538, the processor 350 may build a segment list with all the segments assigned. At block 539, the processor 350 may pick the first segment from the list and in decision block 540, the processor 350 may determine whether the first segment has outgoing edges.

If the first segment does not have outgoing edges (“NO” at block 540), the processor 350 may perform block 544, which will be described below. If the first segment has outgoing edges (“YES” at block 540), the processor 350 may decide in decision block 541 whether all frontier nodes are already shared with a segment other than the first segment picked at block 539. If all the frontier nodes are shared with other segments (“YES” at block 541), the processor 350 may perform block 544 described below; otherwise, if there are frontier nodes that are not shared with other segments (“NO” at block 541), the processor 350 may perform block 542.

At block 542, the processor 350, may add outgoing edges of an unshared frontier nodes to the first segment, followed by block 543 wherein the processor 350 may set a new found nodes discovered in the exploration as the new frontier nodes. Then, at block 539, the following segment from the list may be picked.

The processor 350 may perform block 544 if either the picked segment (first segment in the first case) does not have outgoing edges or all frontier nodes from the picked segment are already shared with other segments. At block 544, the processor 350 may remove the picked segment from the list, followed by decision block 545 wherein the processor 350 may check whether the segment list is empty. If the segment list is not empty (“YES” at block 545), the processor 350 may pick the next segment from the list and repeats block 539 to block 545 with that next segment. If the segment list is empty, the processor 350 may have identified all subgraph route segments 546. The segments 546 identified in this manner may serve as segments identified at block 535 of FIG. 5A.

In the example of FIG. 5C, the system 300 may take for example a sub-graph route 536 (e.g., outputted by block 515 described above), that may include undirected edges as an input and identify the plurality of segments within the sub-graph route. FIG. 5C is a flowchart of method 535B to identify segments in a sub-graph route that includes undirected edges, according to an example of the present disclosure.

At block 538B, the processor 350 may identify triplets within the sub-graph route 536 entities. Furthermore, at decision block 540B, the processor 350 may determine whether all sub-graph route 536 entities have been assigned in a triplet. If all sub-graph route 536 entities have been already assigned in a triplet, then processor may perform block 542B. If there is at least one sub-graph route 536 entity that has not been assigned to a triplet, the processor may perform block 538B again up to the point that all sub-graph route 536 entity have been assigned to a triplet.

At block 542B, the processor 350 may name each triplet to be a segment. Furthermore, at decision block 544B, the processor 350 may determine whether all triplets are assigned to a segment. If there is at least one triplet that is not assigned to a segment, processor 350 may perform block 542B up to the point that all triplets are assigned to a segment. If all triplets are assigned to a segment, all sub-graph route segments may have been identified 546, which is the output of method 535B. The segments 546 identified in this manner may serve as segments identified at block 535 of FIG. 5A.

The above described programmed hardware referred as system 300 for solving a graph route into a set of possible relationship chains may implement the system engines as disclosed in the following example of the present disclosure.

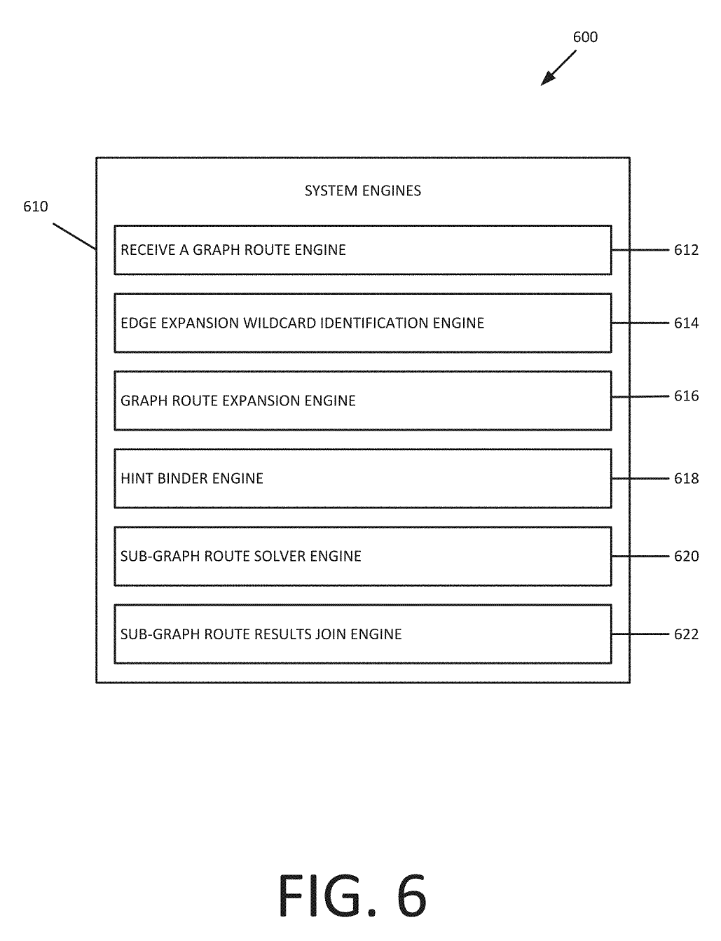

FIG. 6 is a block diagram illustrating a system 600 for solving a graph route into a set of possible relationship chains, according to an example of the present disclosure. The system 600 of the disclosed example includes a set of engines 610. Each of the engines may be implemented by computing hardware, or a combination of computing hardware and programming. In some examples, the system 600 may implement the functionality described in FIG. 2.

The system 600 includes: a receive a graph route engine 612; an edge expansion wildcard identification engine 614; a graph route expansion engine 616; a hint binder engine 618; a sub-graph route solver engine 620; and a sub-graph results join engine 622.

The receive a graph route engine 612 executes the instructions to receive a graph route. The receive a graph route engine 612 may perform this functionality in a manner similar or the same as the instructions to receive a graph route 222 as described above in respect of FIG. 2.

The edge expansion wildcard identification engine 614 executes the instructions identify an edge expansion wildcard engine based on the graph route. The edge expansion wildcard identification engine 614 may perform this functionality in a manner similar or the same as the instructions identify an edge expansion wildcard 224 as described above in respect of FIG. 2.

The graph route expansion engine 616 executes the instructions to expand the graph route into a plurality of sub-graph routes based on the edge expansion wildcard. The graph route expansion engine 616 may perform this functionality in a manner similar or the same as the instructions to expand the graph route into a plurality of sub-graph routes 226 as described above in respect of FIG. 2.

The hint binder engine 618 executes the instructions to bind a node type hint into the sub-graph route node. The hint binder engine 618 may perform this functionality in a manner similar or the same as the instructions to bind a hint into sub-graph entities 318 as described above in respect of FIG. 3.

The sub-graph route solver engine 620 executes the instructions to solve the plurality of sub-graph routes in parallel into a plurality of sub-graph routes results. The sub-graph route solver engine 620 may perform this functionality in a manner similar or the same as the instructions to solve the plurality of sub-graph routes in parallel into a plurality of sub-graph routes results as described above in respect of FIG. 2.

The sub-graph route results join engine 622 executes the instructions to join the plurality of sub-graph results into a set of possible relationship chains. The sub-graph route results join engine 622 may perform this functionality in a manner similar or the same as the instructions to join the plurality of sub-graph routes results into a set of possible relationship chains 230 as described above in respect of FIG. 2.

The above described system for solving a graph route into a set of possible relationship chains may implement the method disclosed in the following example.

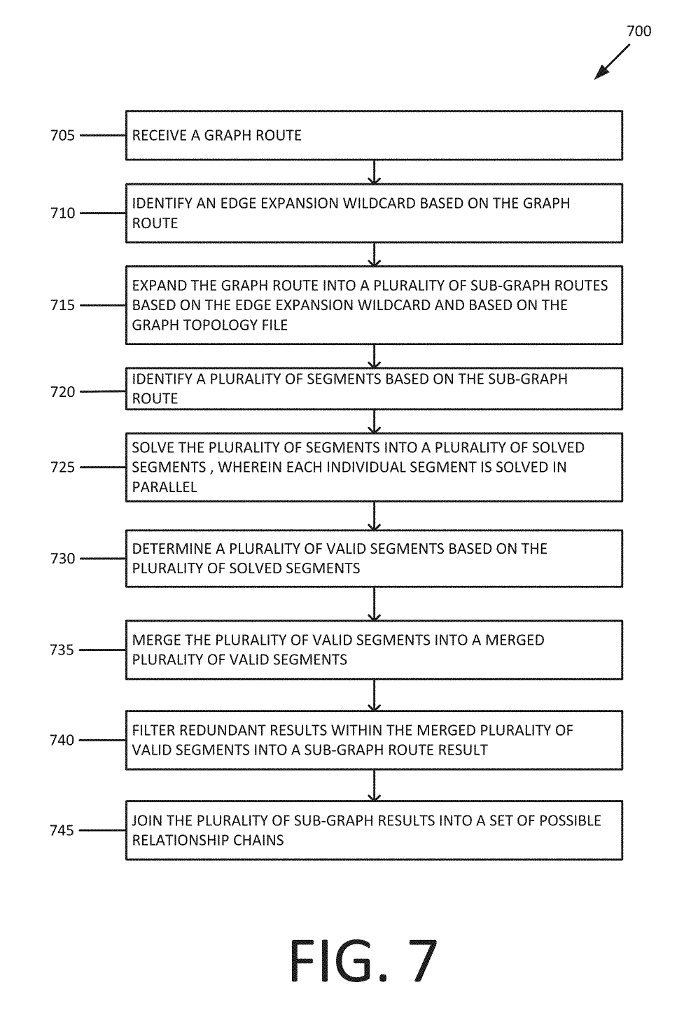

FIG. 7 is a flowchart illustrating a method 700 for solving a graph route into a set of possible relationship chains, according to an example of the present disclosure. Method 700 as well as the methods described herein can, for example, be implemented in the form of machine readable instructions stored on a memory of a computing system (see, e.g., the implementation of system 600 of FIG. 6), executable instructions stored on a non-transitory machine readable storage medium (see, e.g., the implementation of system 200 of FIG. 2), in the form of electronic circuitry, or another suitable form.

At block 705, the method 700 receives a graph route. For example system 200 (via instructions 222) may receive a graph route. The system 200 may receive a graph route in a manner similar as the described above in relation to the receipt of graph route 505.

At block 710, the method 700 identifies an edge expansion wildcard based on the graph route. For example system 200 (via instructions 224) may identify an edge expansion wildcard. The system 200 may identify an edge expansion wildcard in a manner similar or the same as the described above in relation to the execution of identify edge expansion wildcard 510.

At block 715, the method 700 expands the graph route into a plurality of sub-graph routes based on the edge expansion wildcard and based on the graph topology file. For example system 200 (via instructions 226) may expand the graph route into a plurality of sub-graph routes. The system 200 may expand the graph route into a plurality of sub-graph routes in a manner similar or the same as the described above in relation to the execution of replace the edge expansion wildcard with equivalent edge/node pairs 515, plurality of sub-graph routes 520, and the bind the entity type hints into the plurality of sub-graph routes in parallel 530.

At block 720, the method 700 identifies a plurality of segments based on the sub-graph route. For example system 200 (via instructions 228) may identify a plurality of segments based on the sub-graph route. The system 200 may identify a plurality of segments based on the sub-graph route in a manner similar or the same as the described above in relation to the execution of identify segments 535 which includes for example, and depending on the graph topology edge type, either the method disclosed in FIG. 5B, or the method disclosed in FIG. 5C.

At block 725, the method 700 solves the plurality of segments into a plurality of solved segments, wherein each individual segment is solved in parallel. For example system 200 (via instructions 228) may solve the plurality of segments into a plurality of solved segments. The system 200 may solve the plurality of segments into a plurality of solved segments in a manner similar or the same as the described above in relation to the execution of solve every single segment in parallel 550.

At block 730, the method 700 determined a plurality of valid segments based on the plurality of solved segments. For example system 200 (via instructions 228) may determine a plurality of valid segments based on the plurality of solved segments. The system 200 may determine a plurality of valid segments based on the plurality of solved segments in a manner similar or the same as the described above in relation to the execution of are all valid segments solved 555.

At block 735, the method 700 merges the plurality of valid segments into a merged plurality of valid segments. For example system 200 (via instructions 228) may merge the plurality of valid segments into a merged plurality of valid segments. The system 200 may merge the plurality of valid segments into a merged plurality of valid segments in a manner similar or the same as the described above in relation to the execution of merge all segments 560.

At block 740, the method 700 filters redundant results within the merged plurality of valid segments into a sub-graph route result. For example system 200 (via instructions 228) may filter redundant results within the merged plurality of valid segments into a sub-graph route result. The system 200 may filter redundant results within the merged plurality of valid segments into a sub-graph route result in a manner similar or the same as the described above in relation to the execution of filter redundant results 565, and the are all sub-graph routes solved 570.

At block 745, the method 700 joins the plurality of sub-graph results into a set of possible relationship chains. For example system 200 (via instructions 230) join the plurality of sub-graph results into a set of possible relationship chains. The system 200 may join the plurality of sub-graph results into a set of possible relationship chains in a manner similar or the same as the described above in relation to the execution of join all results 575, and the set of possible relationship chains 580.

The above examples may be implemented by hardware, firmware, or a combination thereof. For example the various methods, processes and functional modules described herein may be implemented by a physical processor (the term processor is to be interpreted broadly to include CPU, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, methods and functional modules are implemented as machine readable instructions executable by at least one processor, hardware logic circuitry of the at least one processors, or a combination thereof.

The drawings in the examples of the present disclosure are some examples. It should be noted that some units and functions of the procedure are not necessarily essential for implementing the present disclosure. The units may be combined into one unit or further divided into multiple sub-units. What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

We claim that:

1. A non-transitory machine-readable medium storing machine-readable instructions executable by a processor to cause the processor to:
receive a graph route;
identify an edge expansion wildcard based on the graph route;
expand the graph route into a plurality of sub-graph routes based on the edge expansion wildcard;
solve the plurality of sub-graph routes in parallel into a plurality of sub-graph routes results; and
join the plurality of sub-graph routes results into a set of possible relationship chains.

2. The non-transitory machine-readable medium of claim 1 further comprising machine readable instructions that are executable by the processor to cause the processor to:
identify a plurality of segments based on a sub-graph route of the plurality of sub-graph routes;
solve the plurality of segments into a plurality of solved segments, wherein the plurality of segments is based on individual segments, wherein each individual segment is solved in parallel; and
determine a plurality of valid segments based on the plurality of solved segments.

3. The non-transitory machine-readable medium of claim 2, further comprising machine readable instructions that are executable by the processor to cause the processor to determine whether the plurality of segments are solved.

4. The non-transitory machine-readable medium of claim 3, further comprising machine readable instructions that are executable by the processor to cause the processor to:
upon determining that the plurality of segments are solved,
merge the plurality of valid segments into a merged plurality of valid segments; and
filter redundant results within the merged plurality of valid segments into a sub-graph route result.

5. The non-transitory machine-readable medium of claim 1, further comprising machine readable instructions that are executable by the processor to cause the processor to determine whether the plurality of sub-graph routes have been solved.

6. The non-transitory machine-readable medium of claim 1, wherein the sub-graph route comprise a plurality of undirected edges, the medium further comprising machine readable instructions that are executable by the processor to cause the processor to:
identify a plurality of triplets based on the sub-graph route;
assign a triplet to a segment, wherein the plurality of triplets is based on individual triplets;
solve a plurality of segments into a plurality of solved segments, wherein the plurality of segments is based on individual segments, wherein each individual segment is solved in parallel; and
determine a plurality of valid segments based on the plurality of solved segments.

7. The non-transitory machine-readable medium of claim 1, wherein the sub-graph route comprise at least a directed edge, the medium further comprising machine readable instructions that are executable by the processor to cause the processor to:
assign a segment for each source node of a plurality of source nodes included in the sub-graph route;
set a source node as a segment frontier node;
build a segment list based on the assigned segments; and
select a first segment from the segment list.

8. The non-transitory machine-readable medium of claim 7, further comprising machine readable instructions that are executable by the processor to cause the processor to determine whether the first segment has outgoing edges.

9. The non-transitory machine-readable medium of claim 8, further comprising machine readable instructions that are executable by the processor to cause the processor to:
upon determining that the first segment has an outgoing edge,
determine whether a plurality of segment frontier nodes are shared with a segment from the segment list other than the first segment from the segment list.

10. The non-transitory machine-readable medium of claim 9, further comprising machine readable instructions that are executable by the processor to cause the processor to:
upon determining that the plurality of segment frontier nodes are not shared with a segment and therefore, that a segment frontier node of the plurality of segment frontier nodes comprises an outgoing edge,
add the outgoing edge to the first selected segment;
explore a new found node based on adding the outgoing edge to the first selected segment;
set the new found node as a new segment frontier node; and
select a second segment from the segment list.

11. The non-transitory machine-readable medium of claim 9, further comprising machine readable instructions that are executable by the processor to cause the processor to:
upon determining that either the first segment has not outgoing edges or upon determining that the plurality of segment frontier nodes are shared with a segment from the segment list other than the first segment from the segment list,
remove the first segment from the segment list, and
determine whether the segment list is empty.

12. The non-transitory machine-readable medium of claim 11, further comprising machine readable instructions that are executable by the processor to cause the processor to select a second segment from the segment list upon determining that the segment list is not empty.

13. The non-transitory machine-readable medium of claim 1, wherein the sub-graph route comprises at least a sub-graph route node and further comprises at least a sub-graph route edge, further comprising machine readable instructions that are executable by the processor to cause the processor to:
bind a node type hint on top of the sub-graph route node, wherein the node type hint is based on a graph topology file; wherein the node type hint indicates a node type of the sub-graph node; and
bind an edge type hint on top of the sub-graph edge, wherein the edge type hint is based on a graph topology file; wherein the edge type hint indicates an edge type of the sub-graph edge.

14. A system comprising:
a processor;
a non-transitory machine readable medium storing machine readable instructions to cause the processor to:
receive a graph route;
identify an edge expansion wildcard based on the graph route;
expand the graph route into a plurality of sub-graph routes based on the edge expansion wildcard, wherein the sub-graph route comprises at least a sub-graph route node, wherein the plurality of sub-graph routes is based on at least a sub-graph route;
bind a node type hint into the sub-graph route node, wherein the node type hint is based on a graph topology file, wherein the node type hint indicates a node type of the sub-graph route node;
solve the plurality of sub-graph routes in parallel into a plurality of sub-graph routes results; and
join the plurality of sub-graph results into a set of possible relationship chains.

15. The system of claim 14, wherein the machine readable instructions further include instructions that cause the processor to:
identify a plurality of segments based on the sub-graph route;
solve the plurality of segments into a plurality of solved segments, wherein the plurality of segments is based on individual segments, wherein each individual segment is solved in parallel; and
determine a plurality of valid segments based on the plurality of solved segments.

16. The system of claim 15, wherein the machine readable instructions further include instructions that cause the processor to determine whether the plurality of segments are solved.

17. The system of claim 16, wherein the machine readable instructions further include instructions that cause the processor to:
upon determining that the plurality of segments are solved,
merge the plurality of valid segments into a merged plurality of valid segments; and
filter redundant results within the merged plurality of valid segments into a sub-graph route result.

18. A method implemented by a computer system that includes a physical processor implementing machine readable instructions, the method comprising:
receiving a graph route;
identifying an edge expansion wildcard based on the graph route;
expanding the graph route into a plurality of sub-graph routes based on the edge expansion wildcard, wherein the plurality of sub-graph routes is based on at least a sub-graph route;
identifying a plurality of segments based on the subgraph route;
solving the plurality of segments into a plurality of solved segments, wherein the plurality of segments are based on individual segments, wherein each individual segment is solved in parallel;
determining a plurality of valid segments based on the plurality of solved segments;
merging the plurality of valid segments into a merged plurality of valid segments;
filtering redundant results within the merged plurality of valid segments into a sub-graph route result; and
joining a plurality of sub-graph route results into a set of possible relationship chains.

19. The method of claim 18, wherein the sub-graph route comprises at least a sub-graph route node and further comprises a sub-graph route edge,
the method further comprising:
binding a node type hint into the sub-graph route node, wherein the node type hint is based on a graph topology file; wherein the node type hint indicates a node type of the sub-graph route node; and
binding an edge type hint into the sub-graph route edge, wherein the edge type hint is based on a graph topology file; wherein the edge type hint indicates an edge type of the sub-graph route edge.

20. The method of claim 17, further comprising determining whether the plurality of segments are solved.
